(19) United States
(12) Patent Application Publication
(10) Pub. No.: US 2002/0108260 A1
(43) Pub. Date: Aug. 15, 2002

(54) Thermo-mechanical breaking of round, elliptical or annular shaped bodies

(76) Inventors: Andreas Gartner, Melbourne, FL (US); Anthony P. Pappalardo, Palm Bay, FL (US)

Correspondence Address: JAMES H. BEUSSE , ESQ., BEUSSE, BROWNLEE, BOWDOIN & WOLTER , P.A., 390 N. ORANGE AVENUE, SUITE 2500, ORLANDO, FL, 32801, US

(21) Appl. No.: 09/782,465

(22) Filed: Feb. 13, 2001

(51) Int. Cl. B43L 9/00; B43L 13/00

(52) U.S. Cl. 33/18.1; 33/27.01; 33/27.031

(57) ABSTRACT

A method and apparatus for the separation of round or elliptical bodies from the surrounding material or for annular shaped bodies from the material sorrounding the OD as well as the material confined by the ID. The method applies to non-metallic substances under special consideration of glass.

### BRIEF SUMMARY OF THE INVENTION

The invention relates to a method to break one or more, concentric or non-concentric scribe- or scoreline(s) of round or elliptical shape in a way that no material remains outside the outer diameter nor inside the inner diameter of the resulting body. The method includes the steps of protruding the scribe- or scoreline(s) throughout the entire thickness of the material without actually breaking the material, breaking the OD line (removing the mostly rectangluar or square remainder from the now round or elliptical body) by heating the excess material and either keeping the temperature of the body constant or cooling the body or retarding the rise of temperature in the body relative to the incline of temperature in the excess material or vice/versa in any combination as commanded by the specific properties of the material in question. The resulting gap between body and excess material is a function of the temperature difference, thermal capacity, heat conductivity as well as thermal expansion of the specific material. Either the gravitational pull alone or the gravitational pull in conjunction with a carefully applied supportive mechanical force removes the excess material from the main body. Several methods have been evaluated to accomplish the OD breaking without damaging (chipping) the edge of the main body.

The next step involves the breaking of the ID. The material contained inside the round or elliptical ID line is comparably harder to remove than the excess OD material as the thermal elongation or contraction is a function of the length, which is inevitably less than the length involved in OD breaking. One embodiment, the manufacturing of hardisk platters requires the highest possible edge quality and uniformity while also putting a limit to the thermal treatment of the main (in this case annular shaped) body. Therefore several methods have been explored which keep the temperature of the main body constant while cooling the material inside the ID or slightly heating the main body while cooling the material inside the ID or mechanically deflecting the main body (or any combination as dictated by the material properties) to a certain extent until a condition is reached were either gravitational pull, vacuum pull, pressure air or a mechanical force pushes the material contained by the ID out of the embrace of the main body.

### BACKGROUND OF THE INVENTION

Presently, substrates made from fracturable materials are mainly scribed or scored by mechanical means and broken by application of a bending moment as thought by DeTorre (U.S. Pat. No. 4,109,841). This bending moment acts along the linear scribe- or scoreline. Derivatives of such methodology have been applied to almost all fracturable materials, so for example to plastic by Insolio et. al. (U.S. Pat. No. 4,009,813) or to (silicon) wafers by Pote et. al. (U.S. Pat. No. 4,247,031). Abel (U.S. Pat. No. 4,428,518) teaches a similar method but first time applies it to non-linear geometries as well as narrow elongated strips of glass. Maltby Jr. et. al. (U.S. Pat. No. 4,454,972) shows concerns about the edge quality and teaches a method for partially fracturing linear cuts in glass to facilitate subsequent severance of the body along the score line. McGuire et. al. (U.S. Pat. No. 5,040,342) introduces a subsequent grinding step to clean up the edges. Bando (U.S. Pat. No. 5,888,268) and Lisec (U.S. Pat. No. 5,857,603) teach industrial embodiments of the “break by bending moment” approach.

Tani et. al. (U.S. Pat. No. 5,250,339) describes magnetic recording media made of glass, although without describing the manufacturing of the annular shaped platter itself. Sono et. al. (U.S. Pat. No. 5,268,071) also teaches aspects of the platter manufacturing process, describing the necessity of pristine edges on the raw platters. Hayashi (U.S. Pat. No. 5,569,518) actually measured the impact of microscopic cracks to the stability of hard disk platters. Hagan (U.S. Pat. No. 5,643,649) teaches a method to improve the flatness of glass disk substrates. Kitayama et. al. (U.S. Pat. No. 5,725,625 as well as U.S. Pat. No. 5,916,656) describes methods to strenghten a substrate to circumvent problems arising from cracks or other surface/edge irregularities.

The present production method for annular shaped bodies as used in the hard disk industry foresees the mechanical scribing or scoring on a position outside the nominal OD and inside the nominal ID and a relatively crude breaking operation, which does not particularity take care of edge qualities as the breaking operation is suceeded by a grinding operation which takes the ID/OD back to nominal dimension and removes cracks or chipping from the preceeding manufacturing step. The disadvantage of this method is that the costs of an industrial grinding step are relatively high and demand sizable efforts in the final inspection of the part due to tool wear on part of the grinding heads. Furthermore, as the grinding operation itself introduces cracks, though smaller than the one left by mechanical scribing or scoring, a further step is needed (edge polishing) to guarantee that the platter can be spun with up to 15,000 rpm as required in modem drives.

Recently, a laser based method has been introduced to scribe or score glass or any brittle substrate. Breaking of these scribe- or scorelines has a completely different characteristics from breaking conventional “mechanical” scribes.

This invention relates to a group of methods to break round, elliptical or annular shaped bodies while obtaining the best possible edge quality, under special emphasis, but not limited to, laser scribed or scored substrates.

### BRIEF DESCRIPTION OF DRAWINGS

FIG. 1. illustrates the force applicator used to extend scribe- or scorelines throuighout the entire material thickness

FIGS. 2A & B shows the alternate approach by using a heating element confining the relevant scribe intended to extend

FIG. 3. illustrates the OD breaking by supporting the main body while heating the material surrounding the OD.

FIG. 4 shows the high speed and impulse force impact method to break ID's

FIG. 5 illustrates the combined method of deflecting and heating the main body before ejecting the material confined inside the ID.

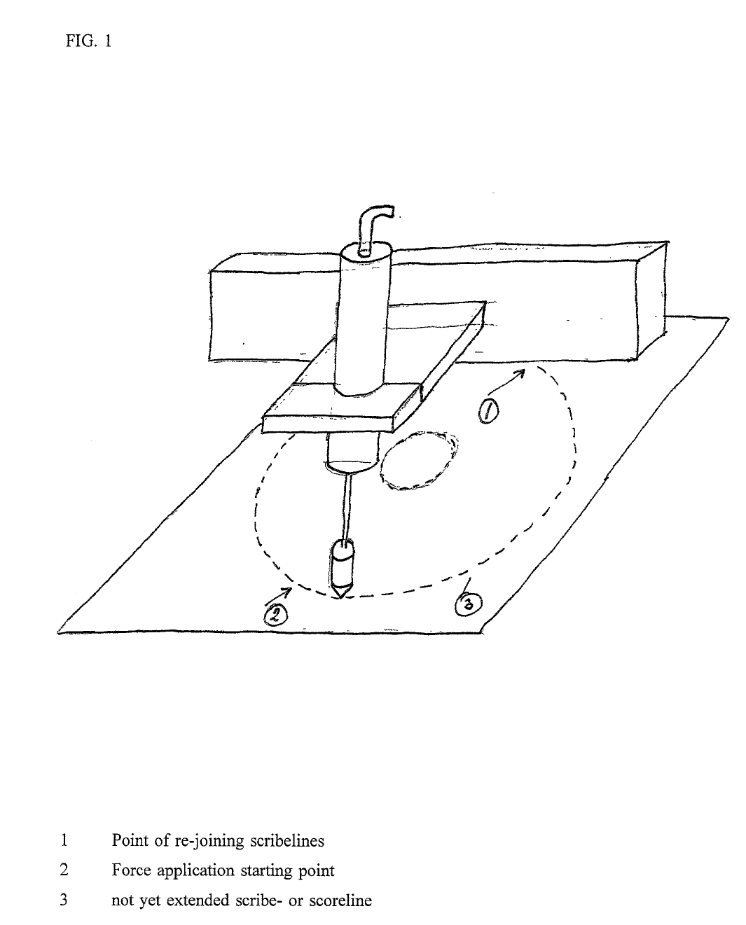

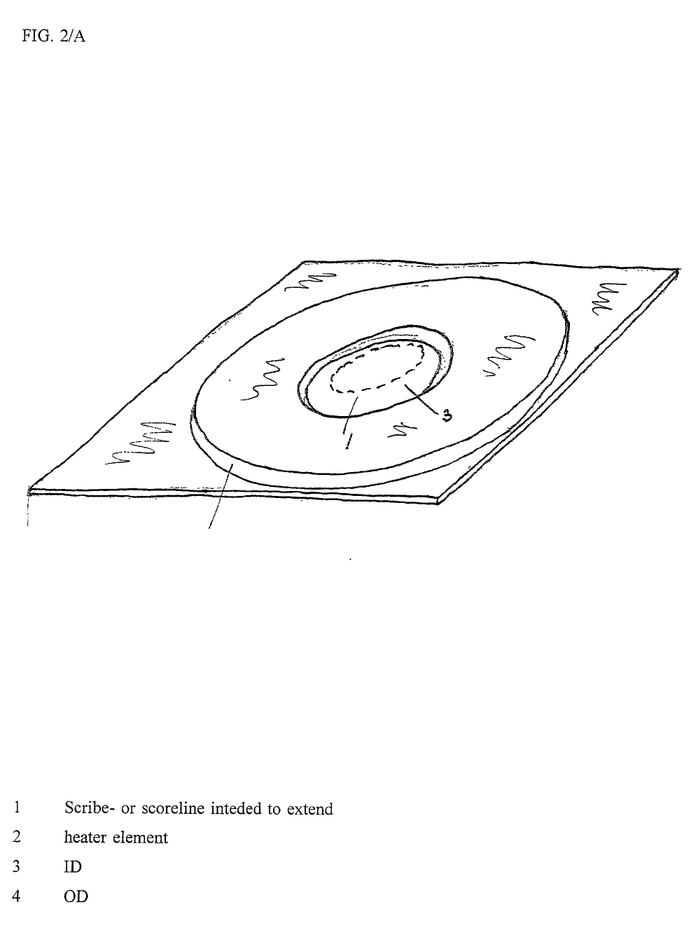

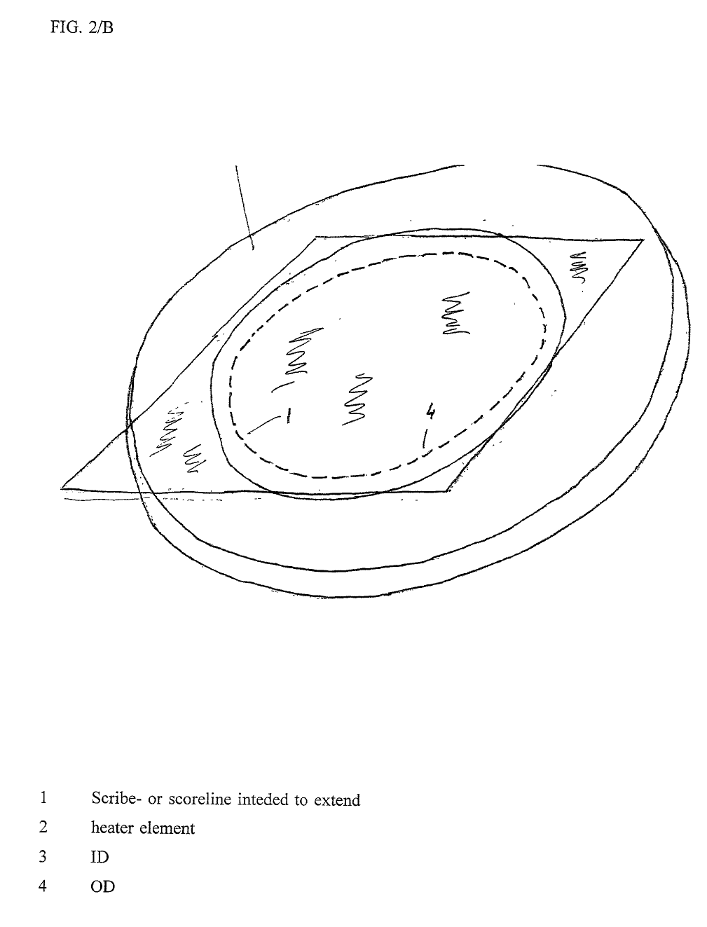

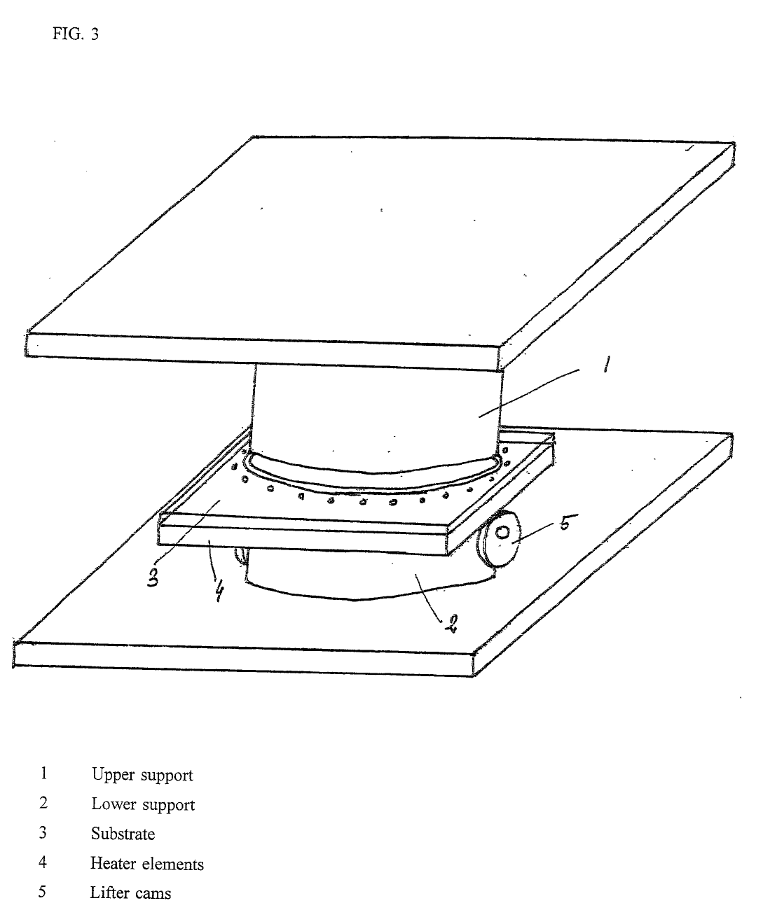

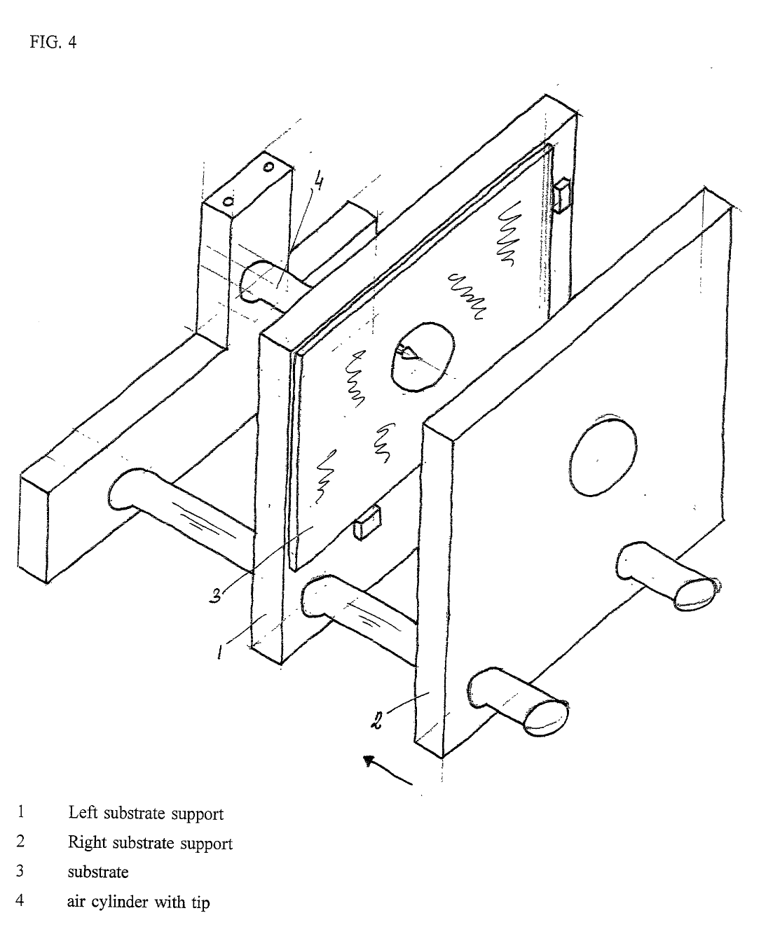

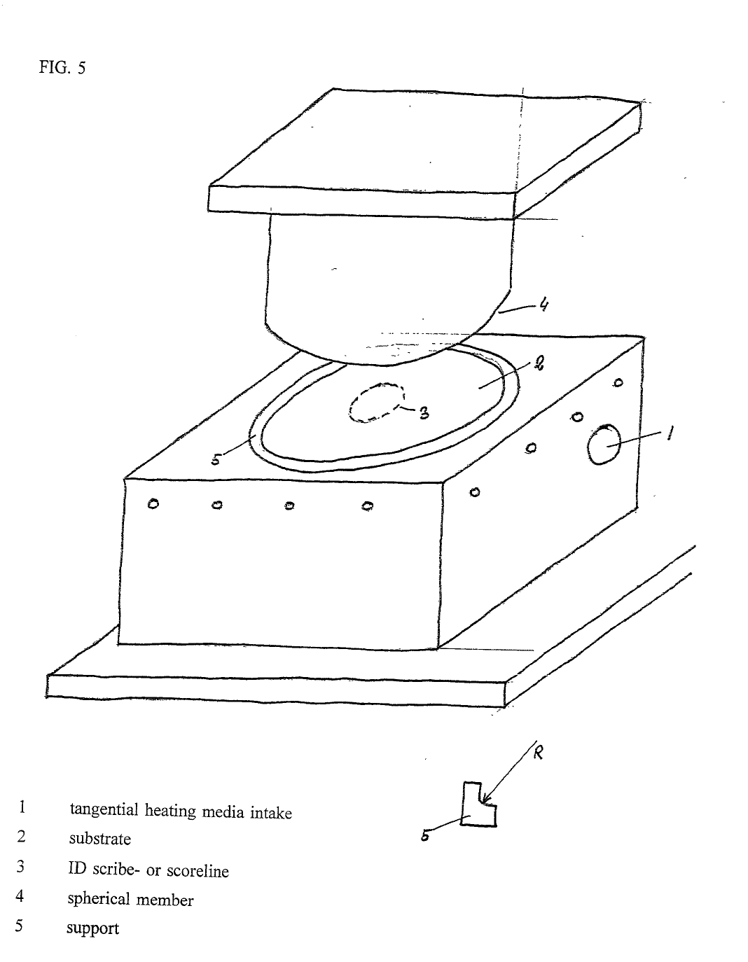

### DETAILED DESCRIPTION OF THE INVENTION

A non-metallic substrate, may it be glass or glass-ceramics, or other fracturable substances is provided by either mechanical or thermo-mechanical means with one or more scribe- or scorelines in either round or elliptical or annular configuration. The result of this operation is a fracture line which in general does not exceed a depth of between 1 to 500 microns. Thus the ratio of scribe depth to the overall thickness of the substrate is in general 1:(2-100). In other words, there is a significant amount of material in the intended extension of the scribe line which has not been impacted by the mechanical or thermo-mechanical scribe operation. The fracture needs now to be extended throughout the material, whereby special care is to be taken that such extension follows a straight path without resulting in steps, nicks or burrs. The prior art tended to protrude the fracture in one step with the actual breaking operation, which inevitably results in more edge damage than a successive method.

Several methods have been investigated for a variety of different materials. From these results we were able to group the results in purely mechanical, thermo-mechanical as well as combined methods. The first group, the mechanical methods, use a force applicator running on the opposite side from the side were the scribe- or scoreline is located in the exact path or to the left or the right from the extact path. For example, the attempt to protrude a fracture on sodalime glass of typical composition (approx. 65 mass percent Silicon-dioxide, approx. 25 mass percent Sodium-oxide) requires a force applicator shaped as a 110 degree tip, made from semi-soft material like Delrin, to be run on the opposite side of the scribe- or scoreline approximately 300 microns outside an, for example, 25 mm ID. Aluminosilikate glass required the same tip geometry but with a main force axis to coincide with the ideal extension of the scribe- or scoreline. As it turned out, for closed geometries as round or elliptical shapes it is important that the force is applied 180 degrees apart from the weakest point in the scribe or scoreline. Typically, where the scribe- or scoreline started and subsequently re-joins with the scribe line approaching after 360 degrees of rotation, the depth is slightly higher than on every point along the circumference. The applied force works again the particular stiffness of the substrate as supported by the substrate holder. Therefore, in the selection of materials for the substrate holders the process can be adjusted to more “give” on the side of the substrate by chosing softer materials. A practical embodiment makes use of Delrin for semi-soft supports, a 1 mm rubber sheet for soft and an aluminum plate for hard support.

The second group, the thermo-mechanical methods make use of the effect, that when exposing a substrate with scribe-or scorelines to a heated surface and maintaining the position there for a certain amount of time, the sudden heat flux from the heated surface to the substrate effectively expands the substrate beyond the yield strength of the material in close vicinity to the scribe- or scoreline(s). The result of such is that the scribe- or scoreline “opens”, or protrudes from it's initial depth throughout the entire depth of the material. In a typical embodiment a annular shaped heater element is heated to a temperature of (but not limited to) between 30 to 400 degree C. The ID of the heater element is larger than the ID scribed or scored in the substrate. When the substrate (of ambient temperature) is made to contact the surface of the heater element for a time between (but not limited to) 0.5 to 5 seconds, the scribe- or scoreline “jumps” open while protruding through the entire thickness of the substrate. It is important to coincide the center of the heater element with the center of the substrate to match the ID of the heater element with the scribe- or scoreline in a concentric fashion. The same process works also the opposite way, by subjecting a substrate with a scribed or scored OD to a heater element with a larger diamter OD than the one of the substrate.

Several other methods exist to provide momentary heat to a substrate which will be obvious to a person skilled in the art.

An alternate embodiment (for substrates sensitive to heat) is to cool the ID by means of a proper cooling device. As such we used a cylindrical chamber filled with liquid Nitrogen, having an OD slightly smaller than the ID intended to open. The chamber is filled with liquid Nitrogen and the substrate with a scribed or scored ID is made to contact the face of the cylindrical chamber, whereby the center of the cylindrical face coincides with the center of the scribe- or scoreline. It is preferred to submerge the entire apparatus in Nitrogen or Argon atmosphere to avoid the formation of ice (from humidity in air) on the cylindrical chamber and in particular on the face of the chamber. The temperature of the face will be between −195 and 0 degree C. as a function of the time it takes a certain quantity of liquid Nitrogen to evaporate. Such sudden cooling of the material contained within the ID scribe- or scoreline causes a contraction which opens the scribe- or scoreline throughout the entire thickness of the material. The same method can be used on the OD as well by using a annular shaped cooler assembly. The main annular body will be contracted versus the surrounding material, effectively opening the scribe- or scoreline. Several derivatives of this method have been explored as well, so for example to force a stream of liquid Nitrogen or similar media towards the surface which needs to be contracted. These derivatives made it though more complicated to manage a uniform temperature distribution on the substrate. Alternate media were used for different temperature ranges, so for example liquid air, dry ice, 2-Methyl butane, dry ice and acetone as well as other mixtures known in the art.

The last group, methods which combine thermo-mechanical as well as force application can be seen as a logical extension of beforementioned methods.

The success of this first operation can be verified by several methods. The most obvious method is based on a visual inspection of the part. The scribe- or scoreline can be seen without optical instruments to protrude from one side of the substrate throughout the entire thickness to the other side. More sophisticated methods incorporate the change of refractivity as a fully extended scribe- or scoreline results in a new optical plane “inside” the material.

The next step is to break the parts apart. Breaking becomes more easy the longer the circumference of the scribe- or scoreline is. For the OD breaking a preferred (but not limited to) embodiment is to heat the surrounding material until an expansion of 5 to 50 microns is achieved and remove it subsequently. As it is desirable to achieve perpendicular edges already in the first step (to open the scribe- or scoreline) the direction of removal is not important.

Methods were though explored to also accomplish the removal of tapered edges, which could be achieved in the first step by either a sharp temperature gradient through the thickness of the material or a secondary scribe- or scoreline on the opposite side of the main scribe- or scoreline, which is slightly smaller or larger than the main scribe- or scoreline. In general, the addition of a secondary scribe- or scoreline on the opposite side does not improve the accuracy of the first process step in terms of edge quality but can be used as a technique to form slightly tapered edges depending on the position of the secondary scribe relative to the position of the main scribe. The breaking of a tapered scribe is dependent on the direction of removal and therefore the substrate orientation on the breaking assembly needs to account for the taper orientation.

In a practical embodiment an OD breaker consists of either a heater element or any other source of heat (heated air, propane torch) capable of achieving a uniform heat distribution, focused to the material surrounding the OD as well as any mechanical mean of removing such expanded material. The most simple apparatus heats the material outside the OD until a gap of 5 to 50 microns (depending on the material and edge geometry) has been achieved and subsequently let's gravity take over the moment a sufficient expansion has been achieved. Gap dimensions less than the range given were explored but resulted, while still feasable, in a higher probablility of edge chipping and were therefore not utilized. More sophisticated devices use mechanical means to move the hot material out of the way once it sufficiently expanded. The main body can be supported in this operation by a upper as well as lower support, not only to mechanically fix the position but also to protect the main body from the heat destined to the sorrounding material.

This method is preferred over cooling the main body as the stress submitted to the main body is held to a minimum. Nonetheless, for some substrates the opposite method, so to cool the main body and remove the material sorrounding the OD once a sufficient gap has formed can be used as well.

The sequence of breaking operations is important. The sorrounding material of the OD scribe- or scoreline is most of the time rectangular or square. Therefore, every point along the circumference of such body would have a different distance to the center of the part, only mirrored sidewise. If now the body is supported along this perimeter in an attempt to break the ID, a complex stress field would emerge duplicating the geometry of the circumference, which would impact the removal of the ID as the expansion would not be uniform and binding occurs between the main body and the material inside the ID.

The ID breaking according to this invention can be accomplished by several methods, which again can be grouped in mechanical, thermo-mechanical or combined methods.

The first mechanical method explored under the scope of this invention was the destruction of the ID by a momentary force impulse toward a small area on the ID, preferrably in the center of the ID. In this embodiment a hardened steel tip with a tip diameter of several microns only was accelerated towards the unsupported material inside the ID, while the main body was supported by lower and upper or left and right support chucks. The steel tip impacted on the glass surface with a speed between 1 and 50 m/s, whereby for example on sodalime glass of typical composition a speed of 23 m/s proved sufficient. For a person skilled in the art it becomes obvious that an ever higher speed would be beneficial but is accompanied by higher mechanical efforts to be achieved. This method can be accompanied by deflecting the material inside the ID scribe- or scoreline prior impact by for example means of vacuum. It has been proven that on harder glass (alkaline earth silicates) or glass ceramics a certain pre-stress on the material inside the ID by application of vacuum is beneficial to the uniformity of results.

This method uses an un-expanded ID sribe- or scoreline, where depending on the scribe or scoring method used there is virtually no gap between the main body and the material inside the ID. It is therefore important to adjust the metal tip to the exact center of the ID scribe- or scoreline. This method is less accurate in terms of edge quality when the thickness of the substrate increases, as an initial deflection occurs prior to the destruction of the material, which tends to create chipping on the opposite side of the tip impact.

Other mechanical methods were explored but proved useful only in combination with thermo-mechanical methods, which will be described later.

The second group of ID breaking methods according to this invention describes thermo-mechanical efforts. The first embodiment in this group is a method to cool the material inside the ID scribe- or scoreline until a distinct gap forms between the main body and the material inside the ID and then eject the ID by means of a uniformly applied force to avoid tilting. The gap necessary to cleanly eject the material inside the ID was discovered with 0.5 to 50 microns, depending on the characteristics of the material as well as the thickness of the substrate. The governing principle is described by imagining the material inside the ID as a cylindrical body, much wider than tall. To push such a cylindrical body out of the confinement of the surrounding material (the main body) it is necessary to maintain the parallelism of the main surfaces. Even a slight tilt of the cylinder would inevitably result in binding between the edges of the main to the cylindrical body. Such binding, when occured, can be overcome by an increase in force, but leads to chipping and other effects along the edge of the main body, which we set out to avoid in first place.

Cooling of the cylindrical body confined in the boundaries of the ID scribe- or scoreline can be accomplished either with an assembly as used in the first step, a chamber type reservoir for liquid Nitrogen or another suitable coolant, which in turn is pressed to the surface of the cylindrical body. It is important to provide uniform contact as otherwise the contraction does not have the same value in all directions. Preferrably with the same chamber face as used for cooling the material it is in turn pushed out of the confinement of the main body. Again, submerging the entire apparatus in inert atmosphere such as Nitrogen helps to avoid the formation of snow on the chamber face, which mainly poses a problem in terms of the geometry while extracting the ID material.

The second embodiment provides heat to the main body in order to expand the substrate. It turned out that conduction heating is not preferrable but rather using an indirect heat media such as heated air or other heated gaseous or even liquid media can be utilized. The substrate is held along the circumference of the meanwhile broken OD and provisions are taken to avoid (or reduce) heat flux towards the material inside the ID such that a significant temperature difference occurs between main body and material inside the ID. A preferred embodiment herefore is to supply the heat media from an tangential intake to the chamber where the substrate is held on top. Therefore, given a certain media speed an area of lower pressure occurs underneath the ID material. A cone with it's wide side underneath the ID material was also used to provide a “shadow” area, where the heat flux is at least reduced in comparison to the heat flux in the main body. After a sufficient gap has formed due to the thermal expansion of the main body (0.5 to 50 microns) the material inside the ID is ejected by either gravity pull or by mechanical means.

The third group, the combination of mechanical as well as thermo-mechanical methods has proven to give the best results in terms of edge quality and overall integrity of the remaining main body. In a preferred embodiment, the substrate is held along the circumference of the OD in a chuck which mimics the shoulder arc of a sphere. Without load the substrate rests only on the lower edge of the circumference and is held in position by vertical alignment supports incorporated in the chuck design. A member with a spherical face will be put in contact with the substrate to determine an un-deflected Zero position and then moved in further against the chuck to achieve a fully supported, controlled deflection of the main body. Due to this deflection, also the lower side of the main body (in the vicinity of the OD circumference) makes full contact wih the matching spherical radius of the support chuck. The deflection rate is chosen as a function of the material characteristics and is mainly influenced by the stiffness and the Young's modulus. Deflection rates between 0 and 500 microns (on 95 mm OD, 25 mm ID) have been evaluated, but this invention is neither limited to this deflection range nor to the dimension of the main body which was given as an example.

When the desired deflection is achieved a heat flux to the main body is generated using the same methods as described before. A preferred embodiment is the use of heated air, as it is simple to control in terms of flow rate and temperature as well as readily available. Certainly this invention is not limited to air as media, as a person skilled in the art can easily substitute the media to achieve a different set of parameters in terms of thermal conductivity and heat capacity of the media. The same provisions apply to avoid or reduce the heat flux to the material inside the ID, whereby the use of a simple cone with it's wide side towards the material inside the ID, positioned just 1.5 times the material thickness underneath the substrate is sufficient to provide a temperature gradient of 100 to 150 deg. C. as long as the heating is done as rapidly as possible. For the typical substrate size of 95 mm OD heating to process temperatures is ideally accomplished within 5 to 10 seconds. When the main body has expanded and a gap of between 0.5 and 50 microns formed, either gravity pull or a forced ejection by pressure air supplied by a provision in the spherical deflection plate is used to remove the ID material from the confinement of the main body.

The careful deflection of the main body results in a cone-shaped gap which opens towards the lower side of the apparatus to facilitate the action of gravity or the forced ejection. In this embodiment the parallelism of the face of the cylindrical material to the face of the main body (or in this case the tangent to the face while in deflection) is less critical as even when a slight tilt occurs the cone shape of the gap still provides ample (and increasing as a function of extraction progress) room to avoid edge chipping.

For glass and other materials with a defined temperature in excess of which every deformation becomes permanent it is important that the process temperature is chosen to never exceed this so called “Strain Point”. Therefore, after ejection of the material inside the ID the deflection is taken back to Zero and the heat flux is stopped. The annular shaped body such formed shows perfectly perpendicular edges without chipping on either side.

We claim:

1. A method to extend a surface bound round or elliptical scribe- or scoreline or a multitude of scribe- or scorelines as found in annular shaped bodies throughout the entire thickness of the material, such forming at least two distinct bodies.

2. A method as described under 1./ by using a force applicator inside or outside or coinciding with the intended extension of the scribe- or scoreline, whereby the substrate rests on a material of suitable softness.

3. A method as described under 1./ by using a sudden heat flux to the part of the substrate confining the scribe- or scoreline intended to extend.

4. A method as described under 1./ by using a sudden negative heat flux (cooling) to a part of the substrate inside the scribe- or scoreline intended to extend.

5. A method to break the OD by increasing the previously formed gap and removing the sorrounding material.

6. A method as described under 5./ by heating the material sorrounding the OD.

7. A method as described under 5./ by cooling the material inside the OD.

8. A method of removing the material confined inside the ID by forcing a sharp tip with high speed and impulse towards the material to effectively destroy it.

9. A method to break the ID by increasing the previously formed gap and removing the material confined by the ID by either gravity pull or forceful ejection.

10. A method as described under 9./ by heating the main body which confines the material inside the ID.

11. A method as described under 9./ by cooling the material confined inside the boundaries of the ID.

12. A method as described under 9./ by deflecting the main body to create a tapered gap and heating the main body to increase such gap or cooling the material inside the ID to the same effect.
